(19) United States
(12) Patent Application Publication
(10) Pub. No.: US 2010/0239724 A1
(43) Pub. Date: Sep. 23, 2010

(54) TOASTER WITH COOLING AIR STREAM

(75) Inventors: LOREN VELTROP, CHICAGO, IL (US); CHRISTOPHER B. LYONS, LAGRANGE PARK, IL (US); MICHAEL M. MACIEJEWSKI, SAINT CHARLES, IL (US); DONALD VAN ERDEN, WILDWOOD, IL (US)

Correspondence Address: Docket Clerk, 1000 JORIE BOULEVARD SUITE 144, OAK BROOK, IL, 60523, US

(73) Assignee: PRINCE CASTLE INC., CAROL STREAM, IL (US)

(21) Appl. No.: 12/407,691

(22) Filed: Mar. 19, 2009

(51) Int. Cl. A23L 1/025; A47J 37/08

(52) U.S. Cl. 426/240; 99/332; 99/401

(57) ABSTRACT

A method of toasting a food product like an English muffin irradiates the food product with infrared (IR) energy from an infrared energy source while simultaneously directing an unheated air stream toward the food product.

### BACKGROUND OF THE INVENTION

Many restaurants serve toasted breads and toasted English muffins as regular menu items. Many of those menu items include sandwiches that are comprised of toasted English muffins and toasted sandwiches.

Toasted food products have a distinctly different flavor than to the same products prior to toasting. Toasting a food product also changes the bread product's color and its texture. In addition to changing flavor, color and texture, the toasting process often gives off a pleasing aroma.

Toasting food products like sliced bread, English muffins, bagels, pizza and other bread products is usually accomplished using infrared energy emitted from one or more electrically-heated wires in a toaster or broiler. The process of toasting, which is also referred to herein as browning, is the result of a chemical reaction known as the Maillard reaction. The Maillard reaction is defined by some, or considered to be the reaction between carbohydrates and proteins that occurs upon heating and which produces browning.

It is believed that when the Maillard reaction goes too far or too long, carbohydrates in a bread product will oxidize completely and form carbon. Carbon absorbs light. The surface of a burned bread product therefore appears black. The term “burn” is therefore considered to be the thermally-induced oxidation of carbohydrates to a point where the carbon content of the bread product surface is high enough to absorb visible light that impinges on the bread product surface and therefore make the surface of the bread product appear to an ordinary observer to be black in color.

A well-known problem with prior art toasters of all kinds is that they often cannot consistently achieve a uniform browning or toasting across bread product surface in the same amount of time. Because of their mass, surface irregularities and temperatures, bread products like English muffins are especially difficult to uniformly and consistently brown in a short amount of time period because the peaks and valleys of an English muffin's surface are at different distances from the IR source that effectuates the toasting process. Since many restaurant operators need and prefer to be able to toast bread products like English muffins as quickly as possible, attempts to shorten browning time by simply increasing the input infrared energy usually results in more bread products being burned rather than toasted. A toaster and a method of toasting food products like bread and English muffins and which can consistently provide uniform browning in a relatively short period of time would be an improvement over the prior art.

### BRIEF DESCRIPTION OF THE DRAWINGS

FIG. 1A is a perspective view of a high-speed toaster with a cool air blower;

FIG. 1B is a perspective view of an alternate embodiment of a high-speed toaster with a cool air blower;

FIG. 1C is a perspective view of yet another embodiment of a high-speed toaster with a cool air blower;

FIG. 2A is a schematic cross-sectional view of the toaster shown in FIG. 1A;

FIG. 2B is a schematic cross-sectional view of an alternate embodiment of the toaster shown in FIG. 2A;

FIG. 3A is a schematic cross-sectional view of the toaster shown in FIGS. 1B and 1C;

FIG. 3B is a schematic cross-sectional view of an alternate embodiment of the toaster shown in FIG. 3A;

FIG. 4 is a perspective view of an alternate embodiment of a substrate and heating elements for use in a high-speed toaster with a cool air blower;

FIG. 5 is a perspective view of an alternate embodiment of a rectangular substrate and heating elements for use with a high-speed toaster with a cool air blower;

FIG. 6 is a perspective view of an alternate embodiment of a substrate and heating elements for use with a high-speed toaster with a cool air blower;

FIG. 7 is an alternate embodiment of a substrate and heating filaments for use with a high-speed toaster with a cool air blower.

FIG. 8 is a cross-sectional view of the heating elements shown in FIGS. 4, 5, 6;

FIG. 9 is a flow chart showing steps of a first method of heating a food product;

FIG. 10 is a flow chart of a second method of heating a food product;

FIGS. 11A and 11B are steps of a third method of heating a food product.

### DETAILED DESCRIPTION

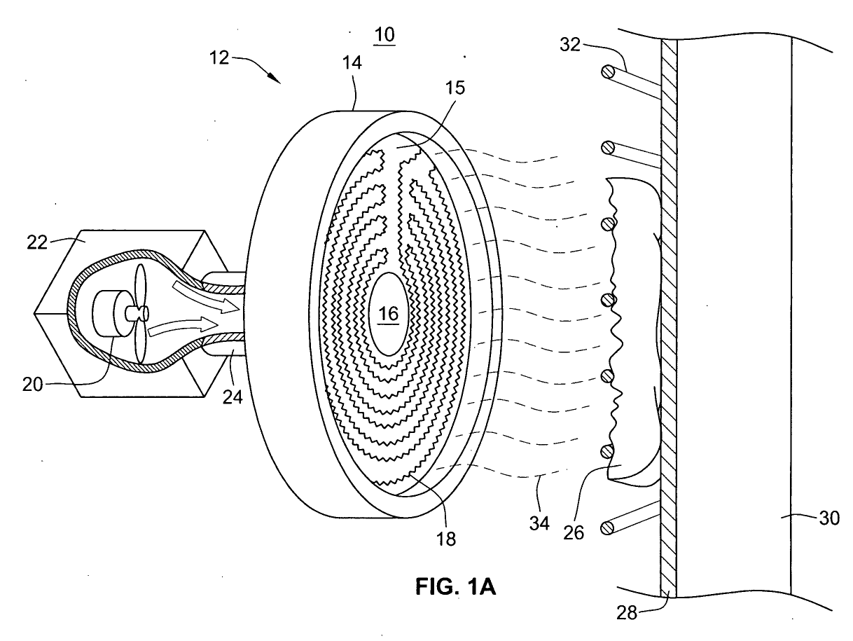

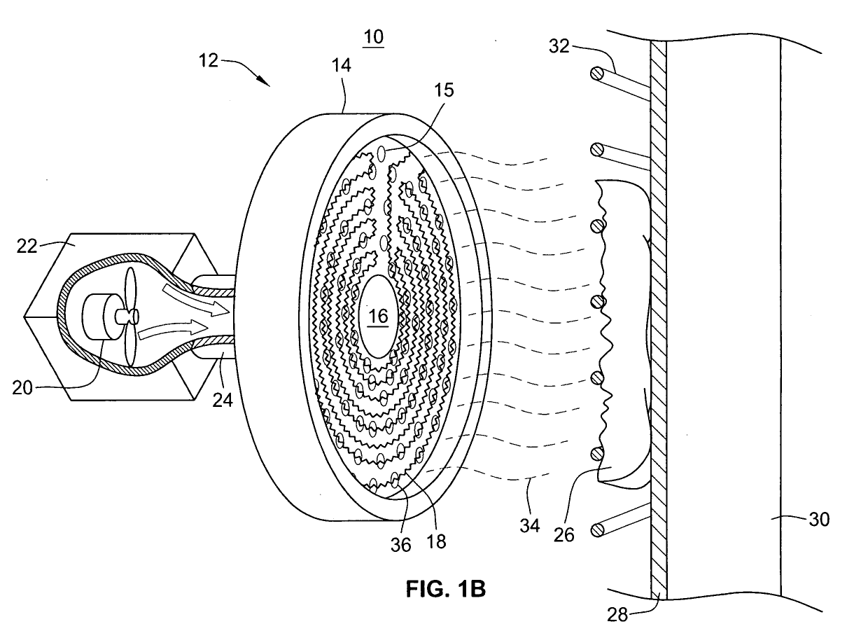

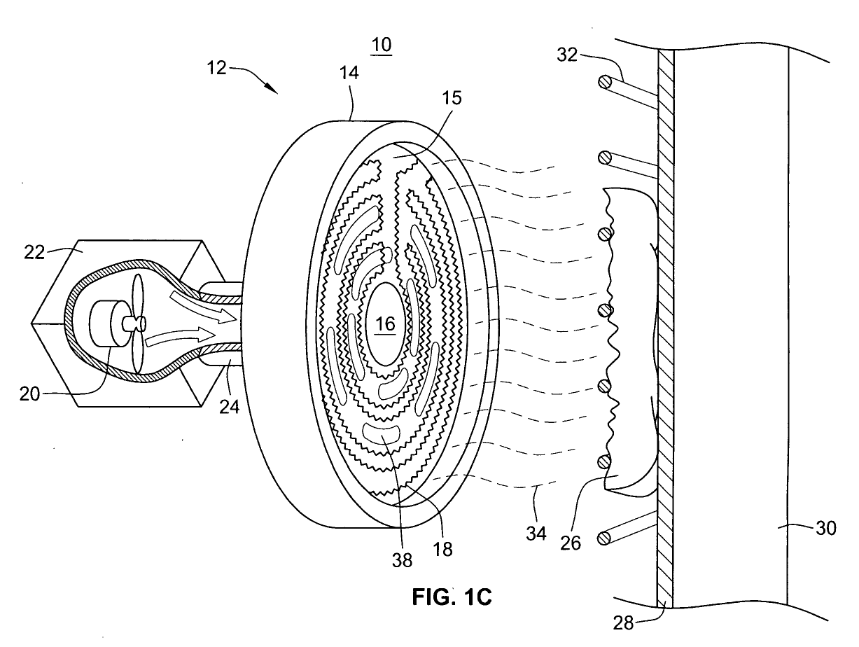

FIG. 1A is a perspective view of a first embodiment of a toaster 10 with a cooling air stream and which can toast bread products that include but which are not limited to sliced bread, English muffins, bagels, pizza and flat bread, in as little as fifteen seconds or more, without burning them. The toaster 10 is comprised of an infrared-emitting (IR) heater 12 that directs IR energy toward a food product 26 to be toasted and a blower 20 that directs unheated and therefore relatively cool air toward the surface of the food product 26 to be toasted. The toaster 10 thus operates by irradiating the food product 26 with IR while simultaneously blowing relatively cool, i.e., unheated air, toward the food product 26.

In FIG. 1A, the IR-emitting heater 12 portion is comprised of a round, generally disc-shaped thermally insulating substrate 14 made from thermally insulating materials such as ceramic, mineral fiber composites, ceramic fiber composites and/or glass fiber composites. The round substrate 14 has a front face or surface 15, which supports an electrically-heated, IR-emitting wire or filament 18 wound around a centrally-located hole 16. The blower 20 forces unheated room air through a hole 16, which extends completely through the substrate 14 from the front surface 15, through a rear face or surface, not shown in FIG. 1A.

The front face 15 of the substrate 14 is substantially planar and is optionally provided with a heat-reflecting/IR-reflecting thin metallic coating or a foil of aluminum, silver or gold. When electric current flows through the filament or wire 18, it heats up. As current through the wire increases, the temperature of the filament/wire 18 increases. The filament/wire 18 eventually gets hot enough to emit IR. The emitted IR is identified in the figures by reference numeral 34. At least some of the IR that radiates away from the wire 18 and toward the heat-reflecting/IR-reflecting coating will be reflected back toward the food product 26 to be toasted.

As is well known, the emitted IR 34 effectiveness in toasting the food product 26 will be a function of the emitted IR wavelength. Emitted IR wavelength depends on the surface temperature of the filament wire 18. The amount of the emitted IR energy 34 will also be a function of the surface area of the filament/wire 18 that emits IR, as well as the presence or absence of IR-reflective coatings or material that might be used on the front face 15 of the substrate 14. The emitted IR can therefore be quantified by an emitted infrared energy density, which is considered herein to be measured in watts per square inch.

Since at least some of the IR emitted toward the front face 15 is reflected back toward a bread product 26 to be toasted, emitted energy density is considered herein to be the watts input to an IR-emitting heating element, such as a nichrome wire or CALROD™, divided by the surface area of any surface that emits infrared toward the food product. In the figures herein, the front face 15 of the substrate 14 holding the heating element that is covered with IR-reflective coating is considered to be an IR emitting surface. In FIG. 1A, the emitted energy density will be equal to the electric power input to the filament/wire 18 divided by the surface area of the front face 15 of the round substrate 14.

FIG. 1A also shows a blower 20, which is comprised of an electric motor and fan blade, mounted inside a plenum chamber 22 located behind the rear face of the substrate 14. Unheated, room air enters the plenum chamber 22, preferably but optionally through an air filter (not shown), enters the blower 20, also referred to herein as a fan and passes through the blower 20 and into a relatively short duct 24 connected between one side or surface of the plenum 22 and the rear side of the substrate 14. The plenum chamber 22 is unheated. Unheated room air thus enters the blower 20 and flows through the fan/blower 20, through the duct 22, into the through-hole 16 at the rear side 23 of the substrate 14 and out of the through-hole 16 at the front face 15 of the substrate 14.

Those of ordinary skill in the art will recognize that when the toaster is operating, the surface of a hole formed in the substrate 14 will eventually reach a temperature greater than room temperature due in part to heat conduction. When room-temperature air from the fan 20 passes through a hole in the substrate 14, the surface temperature of which is greater than the temperature of the air from the blower 20, some heat will be transferred into air passing through the hole. Stated another way, air passing through a hole or holes in the substrate 14 will in fact be slightly heated. Those of ordinary skill in the art will also recognize that the region between the front face 15 of the heater and the bread product support substrate 28 will also be warm. Air that passes from the through the hole 16 will therefore also absorb at least heat present in the region between the heater substrate 14 and the bread product support substrate 28.

As used herein, unheated air refers to ambient, room air, i.e., air at room temperature. “Room temperature” is considered to be above 50 degrees Fahrenheit but less than about one hundred degrees Fahrenheit. Unheated air specifically includes air or an air stream that has passed through a hole or opening in a substrate, such as those described herein, regardless of the surface temperature of the hole or opening and regardless of how high the air stream temperature might have increased as a result of passing through a hole in the substrate. Unheated air also specifically includes an air stream and portions thereof, which have passed through a hole in a substrate and into or through the region or volume between the face 15 of the heater 14 and the thermally insulating substrate 28, regardless of how high the air stream nominal temperature might have increased due to heat absorption. Unheated air also includes an air stream having a nominal temperature measured at the center of a hole in the substrate 14, to be less than three hundred degrees Fahrenheit.

The chemical mechanism by which the toasters and methodologies described herein are able to toast but not burn an English muffin in as little as 15 seconds is not known. It has been observed however, that when the temperature of air striking the surface of a food product exceeds about 300° Fahrenheit, the surface of begins to burn after about 45 to 60 seconds. The preferred methodology for toasting a bread product such as an English muffin in 15 seconds or more and so that it doesn't burn, is to irradiate the food product with IR while directing one or more unheated air streams onto the food product's surface. The air stream angle of incidence on the food product surface is preferably ninety degrees, i.e., measured relative to the geometric plane of the face 15 of the heater however, in alternate embodiments, the air stream angle of incidence can be at almost any angle greater than about ten degrees relative to the geometric plane of the face 15 of the heater.

In FIG. 1A, a bread product 26, such as an English muffin, is held upright, i.e., on its peripheral edge, against a non-combustible, thermally insulating substrate 28. The substrate 28 in FIG. 1A is attached to a non-combustible, thermally insulating support structure 30. An optional, retaining wire spring 32 holds the English muffin 26 upright, i.e., on its peripheral edge so that the open surface faces, i.e., is directed toward the IR-emitting filament/wire 18 and the air stream from the through-hole 16.

It is important that the unheated air stream(s) strike the surface of a food product. Creating an air stream that will strike the food product surface requires the air to be driven. For purposes of claim construction, it should be noted that the air stream driven through the hole 16 will be substantially columnar in the hole due to the shape of the hole. When the air stream leaves the through hole 16, the shape of the air stream will retain its columnar shape for only a short distance but will nevertheless be columnar or substantially columnar when it leaves the through-hole 16. The portion of the air stream leaving the through hole 16 that remains columnar when it strikes the food product being toasted will depend on factors that include the distance separating the front face of the heater and the food product being toasted and the velocity of the air stream.

When the forced air from the through-hole 16 impinges upon the bread product 26, the air stream diverges from the point of impact on the surface of the bread product 26. Prototype testing revealed that for a given emitted IR energy density, the surface of the bread product 26 tended to burn as the air stream's angle of incidence on the bread product surface decreased from 90°. Stated another way, control of the Maillard reaction decreases as the air stream angle of incidence decreases from normal to the bread product surface.

FIG. 1B is an alternate embodiment of the toaster 10 shown in FIG. 1A. Several secondary air holes 36 that extend through the substrate 14 are distributed around the central through hole 16. The distributed air holes 36 thus provide several unheated air streams that are at least initially columnar and which impinge upon the surface of the food product 26 being toasted. In another embodiment not shown, the air holes 36 are formed in the substrate but the centrally located through-hole 16 is not. Unheated air from the blower 20 thus flows out of the distributed air holes 36. As with the embodiment shown in FIG. 1A, which has a single, cooling air through-hole, the air passing through the distributed air holes 36 of FIG. 1B form several unheated air streams that flow toward the food product 26 being irradiated.

FIG. 1C depicts yet another alternate embodiment of a toaster 10 that irradiates food products with infrared while simultaneously directing a cool, unheated air stream toward the irradiated food product. In FIG. 1C, the holes 36 shown in FIG. 1B are replaced by arcuate slots 38, which are distributed around the center of the round-shaped substrate 14, which also has a through-hole 16. In yet another embodiment not shown, the arcuate slots 38 for cooling air are formed in the substrate 14 but the centrally-located through-hole 16 is not.

For purposes of claim construction, the centrally-located through hole 16 depicted in FIG. 1A, the distributed holes 36 shown in FIG. 1B and the distributed slots 38 shown in FIG. 1C, are different but equivalent embodiments of structures that enable an unheated air stream to be directed toward a food product that is simultaneously being irradiated with IR energy from a IR source such as the filament/wire 18 shown in the figures.

Those of ordinary skill in the art will recognize that some of the IR energy emitted from the heating element 12 will not travel toward the food product being toasted but will instead travel in different directions. Some infrared energy might impinge upon surfaces of holes formed into the substrate causing the surface temperatures of those holes to rise. Most of the most of the infrared energy 34 emitted from the heating element 12 is nevertheless directed toward a food product 26. Since most of the IR and the air stream are directed toward the food product, the IR that is directed to the food product and the air streams are therefore considered herein to be parallel or virtually parallel to each other. As set forth above, the air stream(s) directed to the food product is/are substantially columnar, at least when leaving holes formed through the substrate, and as can be seen from the figures, when the air streams leave the openings 16, 36 or 38, the air streams will be surrounded or substantially surrounded by infrared energy traveling in the same general direction. From an alternate perspective however, the emitted infrared energy can be considered to be surrounded by one or more air streams.

As used herein, the terms “toasting” and “browning” are used interchangeably and refer to the effectuation of a Maillard reaction and an accompanying color change but without burning the bread product. As stated above, burning is considered herein to be the complete oxidation of carbohydrates and/or proteins to form carbon, the concentration of which on a bread product surface is high enough to make the bread produce surface appear to be grey or black to an ordinary observer, when the surface is viewed without the aid of mechanical devices.

A toasted bread product will almost always give off a pleasing aroma whereas burned bread products give off a pungent odor. A toasted bread product will also have a deeper, richer flavor than the same product will have before being toasted whereas burned bread products have a bitter taste that almost all people find objectionable. Toasting a bread product does not create smoke because toasting does not cause carbohydrates and/or proteins to burn. Burning a bread product almost always generates at least a small amount of black smoke, i.e., carbon particles as a by-product of the complete oxidation of carbohydrates and/or proteins.

The darkness of the color change achieved during the toasting process was experimentally determined to be related to the length of time that the bread product was kept in front of the heater 12 and subjected to the aforementioned cool air stream. Heating the bread product with the IR while cooling it with the air stream (processing) for as long as 45 to 60 seconds produced a deeper brown color while processing it for less than about 15 seconds produced only a slight browning. Several different factors can affect toasting time.

Prototype testing revealed that for a given bread product at a given initial temperature, separated from an IR emitter by a fixed distance, the air stream volumetric flow rate, air stream temperature and the emitted infrared energy density all affected the time required to produce a particular, desired food product color change. By way of example, the time required to toast an English muffin to achieve a commonly accepted gold to golden-brown color varied between 20 and about 40 seconds based on IR emitted energy density, air stream temperature and air stream flow rate.

Emitted IR energy density can be controlled by controlling the electric current flowing through the filament/wire 18, the area of surfaces that emit IR as well as the area and reflectivity of surfaces that reflect IR toward a food product. Air stream velocity and flow rate can be controlled by controlling fan speed 20, the fan blade pitch as well as the duct size and/or the use of an optional air-flow controlling damper (not shown) located in the air duct either up stream or downstream of the fan.

While the preferred embodiments use forced air streams that are unheated, i.e., at room temperature, alternate embodiments use an stream temperature that is slightly elevated but kept below about 300° F. While an air stream temperature of 300 degrees is well above room temperature, it is nevertheless well below the surface temperatures of the IR source, which can range from 1000 to 2000° F. A small amount of heat is therefore added in some alternate embodiments, depending on the toasting requirements of a particular bread product.

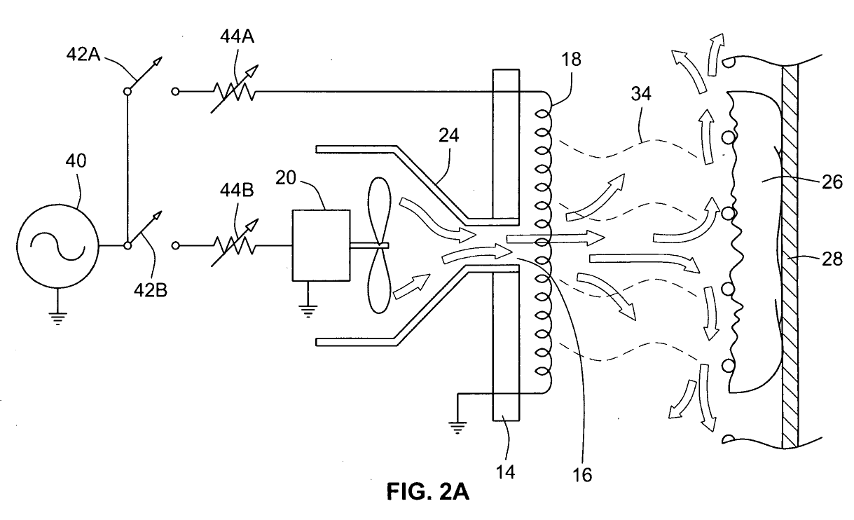

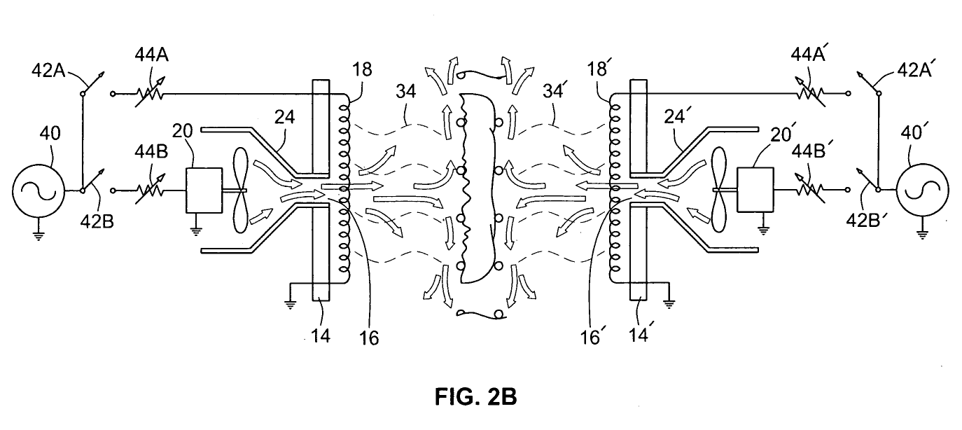

Referring now to FIG. 2A, there is shown a schematic, cross-sectional view of a toaster with a cooling air blower, such as the one shown in FIG. 1A. Unheated room air is driven by the fan 20 through a duct 24 and into the through-hole 16 formed into the substrate 14. When the air passes through the hole in the substrate, it continues to travel toward a food product 26 being toasted. IR energy is represented by sinusoidal broken lines identified by reference numeral 34. Blower air is represented by the arrows that extend through the hole 16 and toward the food product 26.

An alternating current (A.C.) source is electrically connectable to the blower 20 through the “B” side of a double-pole switch, i.e., switch 42B. The power source 40 is also connectable to the electrically heated element 18 through the “A” side of the same double pole switch, i.e., switch 42.

The power provided to the electrically heated filament wire 18 and hence the emitted IR is controllable by a current and/or voltage controller identified by reference numeral 44A. The fan speed is also controllable by a similar current/voltage controller 44B. The controllers 44A and 44B are depicted in the figure as variable resistances, however, the controllers are preferably embodied as either silicon controlled rectifiers (SCRs) or TRIACs, well known to those of ordinary skill in the electronic arts. Those of ordinary skill will recognize that the controllers can also be embodied as rheostats.

FIG. 2B shows an alternate embodiment of the toaster shown in FIG. 2A, which is constructed to toast both sides of a bread product such as an English muffin. As with the embodiment shown in FIG. 2A, unheated room air is driven by the fan 20′ through a duct 24′ and into a through-hole 16′ formed into the substrate 14′. When air passes through the hole 16′, it travels toward the second side of a food product 26, the other side of which is toasted by the toaster mechanism shown in FIG. 2A. Separate controls on each side of the toaster shown in FIG. 2A enable the two sides of a bread product 26 to be toasted differently.

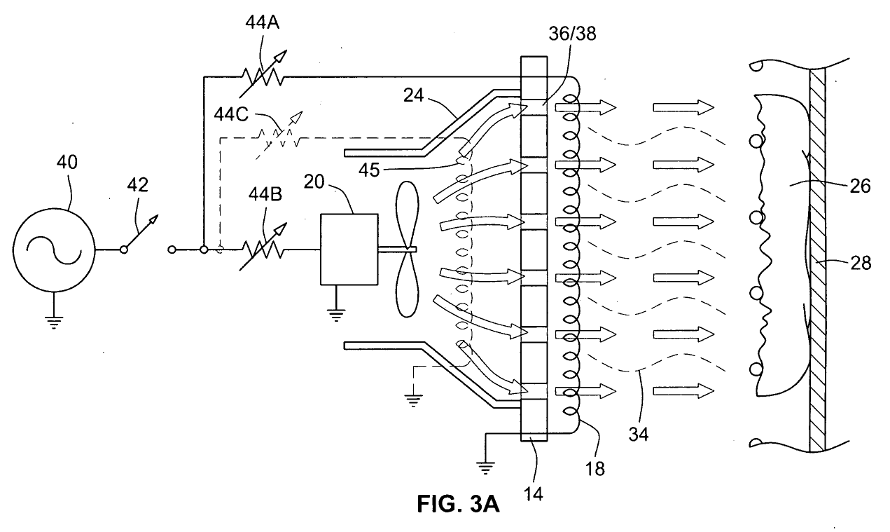

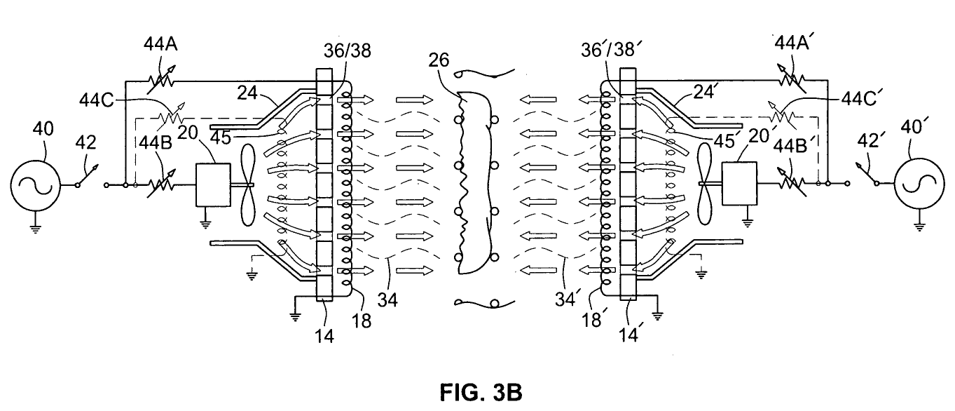

FIG. 3A shows a schematic, cross-sectional view of the embodiments depicted in FIGS. 1B and 1C except that FIG. 3A shows an optional an in-line heating element 45 downstream from the fan 20. The power provided to the optional heater 45 is controlled by a correspondingly optional current/voltage controller 44C. The optional heater 45 and optional controller 44C are depicted in FIG. 3A using broken lines. The air stream temperature rise provided by the optional heater 45 is adjustable to keep the temperature of the air streams leaving holes in the substrate 14, below about three hundred degrees Fahrenheit based on the type of bread product being toasted.

In FIG. 3A, unheated, room-temperature air flows from the blower through multiple holes embodied as the distributed air holes 36 depicted in FIG. 1B, or the arcuate slots 38 depicted in FIG. 1C. The duct 24 shown in FIG. 3 differs from the duct shown in FIG. 2 in that the air driven from the fan 20 is provided to all of the openings 36/38.

FIG. 3B shows an alternate embodiment of the toaster shown in FIG. 3A, constructed to toast both sides of a bread product such as an English muffin. As with the embodiment shown in FIG. 3A, unheated room air is driven by the fan 20′ through a duct 24′ and into a through-hole 16′ formed into the substrate 14′. When air passes through the hole 16′, it travels toward the second side of a food product 26, the other side of which is toasted by the toaster mechanism shown in FIG. 3A. Separate controls on each side of the toaster shown in FIG. 3A enable the two sides of a bread product 26 to be toasted differently.

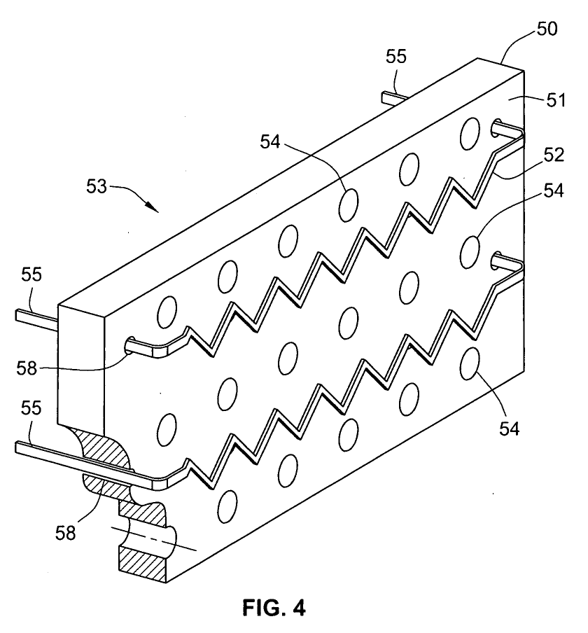

FIG. 4 shows an alternate embodiment of a substrate for use in a high-speed toaster with a cool air source. The substrate 50 shown in FIG. 4 is a rectangular, rectangular parallelepiped-shape ceramic block having a substantially flat front side 51 and a substantially flat back side 53, not visible in FIG. 4. Cooling air holes 54 are spaced apart from each other at regular intervals and arranged in columns and rows. The holes 54 extend through the substrate 50, i.e., between the two sides and provide pathways for air from a blower, not shown in FIG. 4. IR energy is provided heating by crenellated filament wires 52, the ends 55 of which are bent at ninety degrees and extend through smaller-diameter filament wire through holes 58 formed near the ends of the substrate 50.

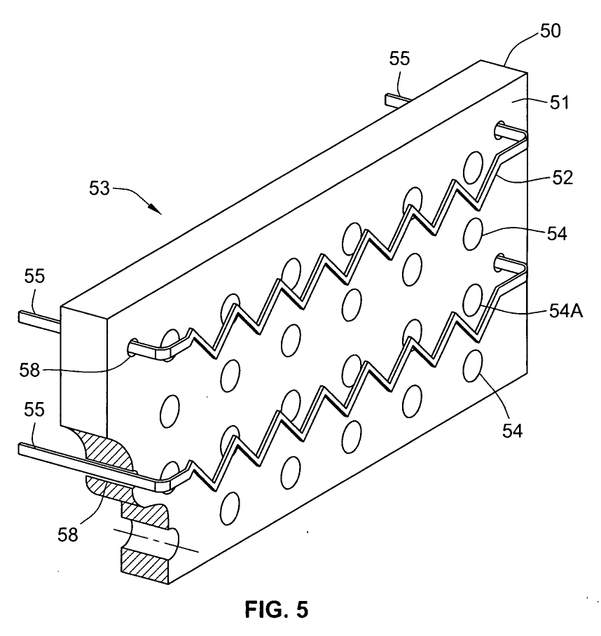

FIG. 5 shows a slightly alternate embodiment of the substrate 50 shown in FIG. 4, the difference being that in FIG. 5, through holes 54A are located directly behind the crenellated filaments 52 in addition to being distributed between the filament wires 52 as shown in FIG. 4. Blowing cool air over the filament wires 52 will tend to cool them and reduce the IR emitted from them.

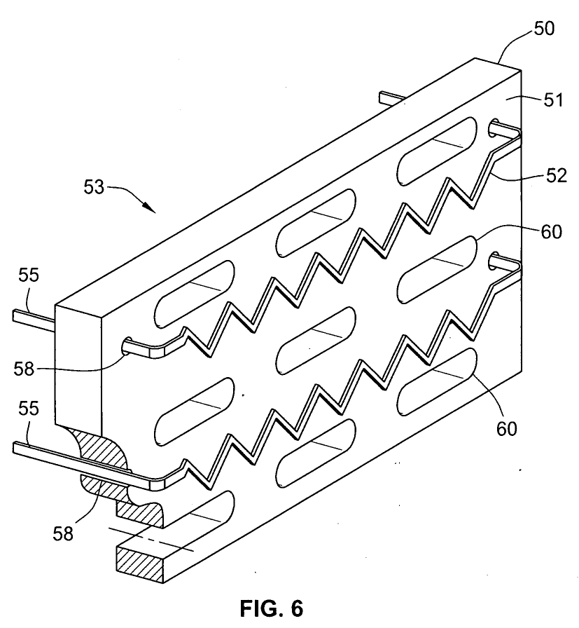

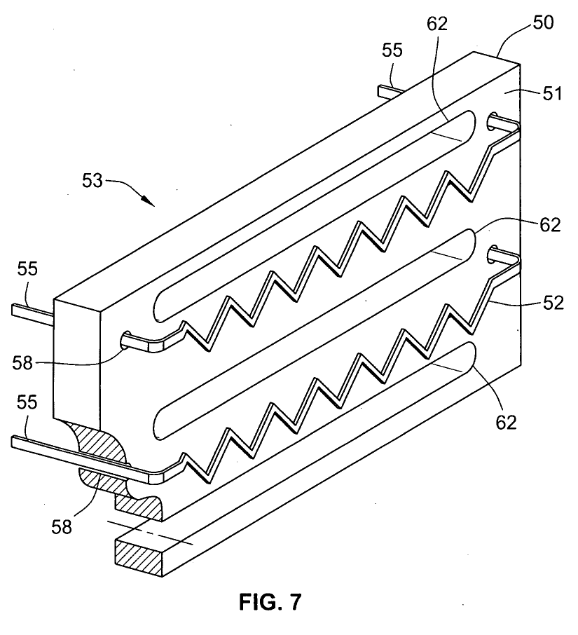

FIG. 6 shows yet another embodiment of a substrate 50 usable with a high-speed toaster having a cooling air stream. In FIG. 6, the holes depicted in FIGS. 4 and 5 are replaced by uniformly-spaced elongated air slots 60. FIG. 7 is yet another embodiment where the substrate 50 is provided with air slots 62 that run nearly the entire width of the substrate 50.

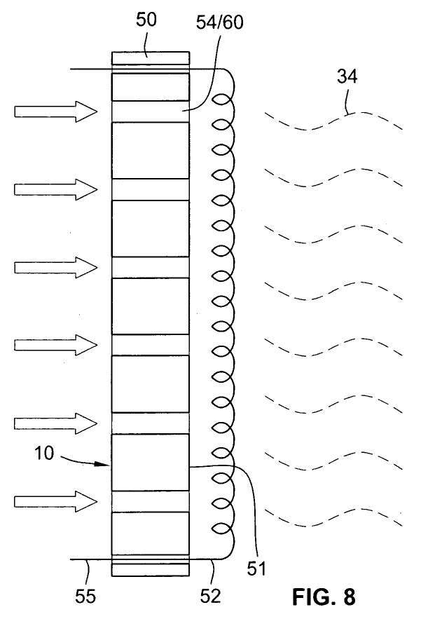

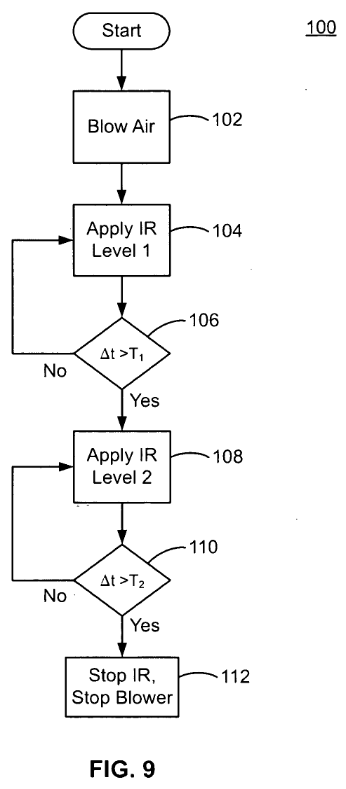

FIG. 8 shows a cross section of the substrates shown in FIGS. 5, 6 and 7. Infrared energy 34 is shown in FIG. 9 as being emitted from the electrically heated filament 52 while an air stream is driven through the holes 54 or 60.

It is not essential that the air stream or streams that impinge on the food product be columnar; air streams of different cross sectional shapes will also work. For that matter, those of ordinary skill in the art will recognize that the shape of the air stream leaving the slots shown in FIG. 6 and FIG. 7 will not be columnar. The air streams flowing from the slots will nevertheless have the same effect that will the substantially columnar air stream leaving the centrally-located hole 16 and the substantially columnar air streams leaving the distributed holes.

Referring now to FIG. 9, there is shown a flow chart, which graphically depicts a first method 100 for heating a food product using IR and a cooling air stream. The order of steps 102 and 104 shows that an air stream is directed to the food product followed by the step of irradiating the food product. In practice, the order of applying IR and cooling air can be reversed from what is shown. In yet another embodiment, the IR and cooling air can be started simultaneously.

Once they are started, the IR and the cooling air are continuously applied to the food product for a first time period identified in 106 as T₁. At the expiration of T₁, the method includes an optional adjustment to the emitted infrared energy density level to a second, lower level 2 as shown at step 108. The second infrared energy density level is maintained for a second time period identified as T₂. The infrared energy and blower are shut off at step 112 at the expiration of T₂.

In experiments, an English muffin was heated with a first infrared energy density for a first time period T₁ of about 15-25 seconds. An air stream at room temperature, i.e., about seventy two degrees Fahrenheit was directed at the English muffin's surface at a ninety degree angle. At the expiration of T₁ the first energy density output energy level was reduced by about 90% to 95%. The second, lower energy density was maintained for an additional 15 seconds, as was the air stream. At the end of T₁ and T₂ the English muffins were uniformly toasted to a medium brown color without burning the English muffin's surface. The total of both T₁ and T₂ was about 35-45 seconds.

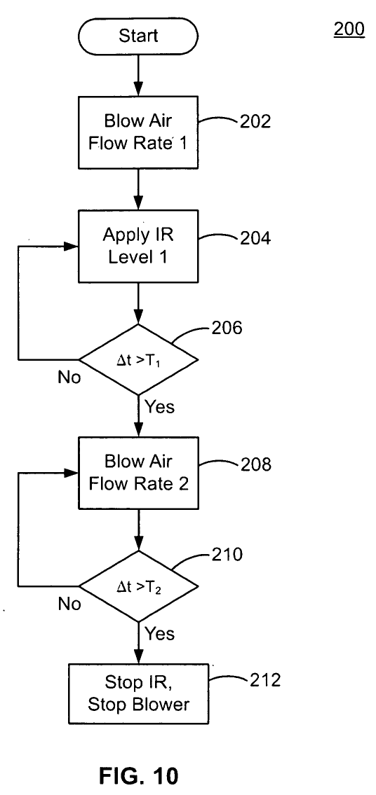

FIG. 10 shows steps of another method 200 for heating a food product. At step 204, a constant IR energy density level is directed to the food product after relatively cool air, i.e., below 300 degrees, is directed at the food product's surface at step 202. As with the method shown in FIG. 9, the IR can alternatively be provided prior to the cooling air or simultaneously with the cooling air. As shown in the figure, the IR directed to the food product is maintained at a fixed output energy density level for a first time period equal to T₁.

At the expiration of T₁ at step 206, the air flow rate is optionally changed to a second, greater or lesser volumetric flow rate at step 208. The second, optional volumetric flow rate is maintained for a second time period T₂. At the expiration of T₂ the infrared and the blower are shut off.

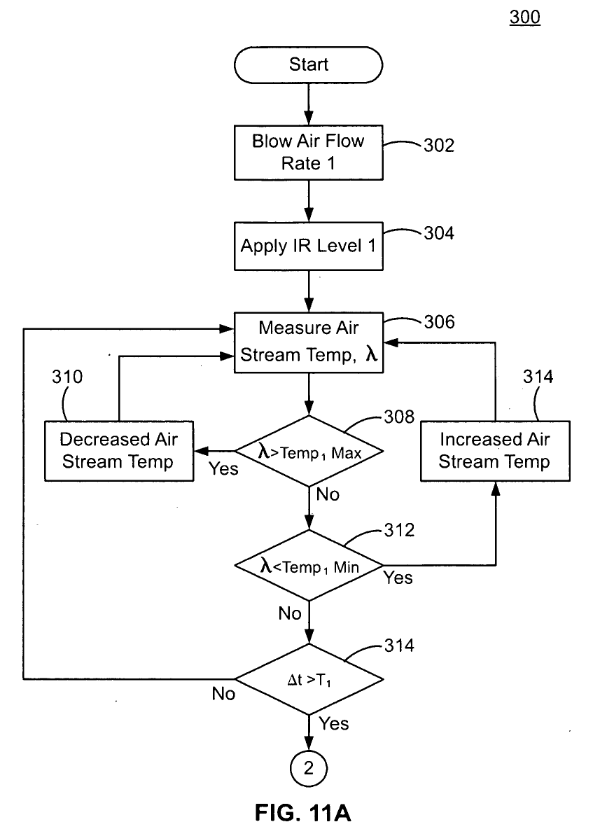

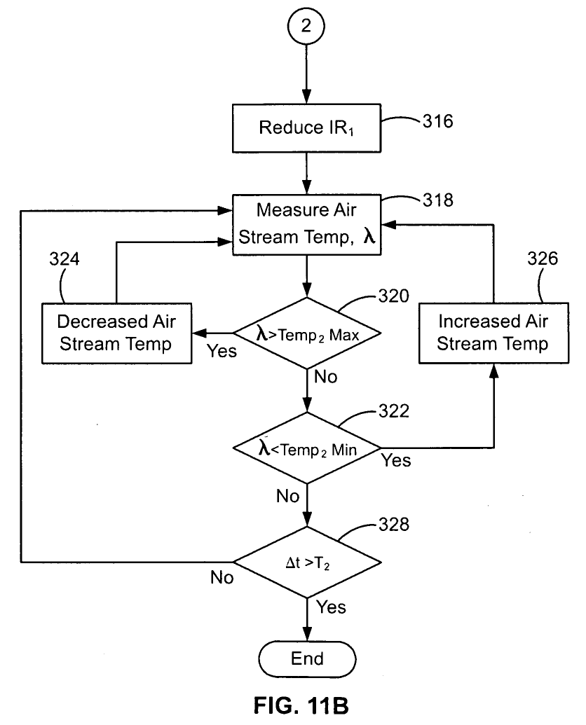

FIG. 11A shows steps of yet a third method 300 for heating a food product wherein the temperature of the air stream is slightly increased using an in-line electric heating element such as the one shown in FIG. 3. Unlike the methods shown in FIG. 9 and FIG. 10, the method shown in FIGS. 11A and 11B uses a constant air flow rate and a constant infrared energy density level but uses an air stream discharge temperature elevated about room temperature by the in-line heater depicted in FIG. 3 or an equivalent thereof, upstream of the blower.

Steps 302 and 304 show that the air flow is started prior to the application of infrared energy, however, as with the other depicted methods, the air flow and IR can be applied simultaneously or the IR can be applied slightly prior to the air stream. Regardless of whether the air or IR is applied first, at step 306, the temperature of the air exiting the blower 22 is measured at step 308 as to whether the air stream temperature exceeds a predetermined maximum threshold value identified in FIG. 11A as Temp₁Max. If the measured temperature from the blower exceeds Temp₁Max, the heat added to the air stream is reduced at step 310 and the air stream temperature is re-measured at step 306.

Steps 306, 308 and 310 comprise a control loop, not exited until the air stream temperature is below Temp₁Max. When or if the air stream temperature is below Temp₁Max, a second air stream determination is made at step 312 to determine whether or not the air stream temperature is above Temp₁Min. If the air stream temperature is below Temp₁Min, the air stream temperature is increased at step 314 by the in-line heater. Steps 306, 308 and 312 are repeated until the air stream temperature is between Temp₁Max and Temp₁Min, the difference between them being a design choice. Once the air stream temperature range is realized, the air stream volumetric flow rate is maintained for a predetermined time equal to T1 as can been seen in step 314.

In FIG. 11B, at the expiration of T₁, the IR emitted from the heater 12 can optionally be changed, i.e., increased or decreased, at step 316. Air stream temperature is thereafter optionally adjusted to be between Temp₂Max and Temp₂Min using steps 318, 320, 322, 324 and 326, which repeat the function performed in steps 306, 308, 312, 314, 310 and 315 of FIG. 11A. After the emitted IR is changed and the desired air stream temperature is achieved, the discharged air stream temperature is thereafter maintained for a second time period T₂. At the expiration of T₂, the blower 22 is shut off and power to the heating element is shut off.

Using the methods depicted in FIGS. 9-11, an English muffin was toasted to a light brown color without burning in as little as 15 seconds, a medium brown in about 35 seconds and a dark brown in about 60 seconds. For the method shown in FIG. 9, the first energy density level was maintained for approximately 20 seconds. T₁ is thus about 20 seconds. At step 108, the IR is reduced by about 85% to about 95% of the initial level and continued for the remaining 15 seconds. T₂ is thus about 15-25 seconds.

For the method shown in FIG. 10, a single energy density level of about x1 and x2 watts per square inch is maintained for the duration of T₁ and T₂. For the method shown in FIG. 9, the blower 20 is configured to produce one volumetric flow rate. In FIG. 10, however, the blower 20 is configured to operate at at least two different velocities to effectuate at least two different air stream volumetric flow rates shown at steps 204 and 208. Alternate embodiments can employ a variable speed motor for the fan 20.

While the preferred embodiments disclosed herein are described with regard to toasting an English muffin, those of ordinary skill in the art will appreciate that the methods and apparatus disclosed herein will have application to the preparation of other foods and/or bread products. The methods and apparatus can be used to cook without burning, sliced bread, pizza, bagels, flat bread and sandwiches in considerably less time than prior art devices that include impingement ovens, toasters and toasting ovens that use infrared and high-temperature and heated air streams, however, bread products like pizza will require more time to cook than fifteen to twenty seconds. The claims should therefore be construed accordingly.

The invention should not be considered to be the foregoing description or any portion thereof. The invention is defined by the appurtenant claims.

What is claimed is:

1. A method of heating a food product comprising the steps of:
irradiating a food product with infrared (IR) energy from an infrared energy source while simultaneously directing an unheated air stream toward the food product;

2. The method of claim 1, wherein the first unheated air stream is substantially orthogonal to the first side of the food product.

3. The method of claim 1, wherein the first unheated air stream is provided by a first fan and the temperature of air entering the fan is at room temperature.

4. A method of heating a food product comprising the steps of:
irradiating a first side of a food product with infrared energy from a first infrared energy source while simultaneously directing at least one substantially columnar unheated air stream toward the first side of the food product;
whereby the first side of the irradiated food product is browned but not burned.

5. The method of claim 4, further comprised of the steps of:
irradiating a second side of a food product with infrared energy from a second infrared energy source while simultaneously directing at least one substantially columnar unheated air stream toward the second side of the food product;
whereby the first side and the second side of the irradiated food product are browned but not burned.

6. The method of claim 4 or 5, wherein the radiated infrared energy direction and the air stream direction are substantially parallel.

7. The method of claim 4 or 5, wherein the air stream is substantially orthogonal to a surface of the food product.

8. The method of claim 4 or 5, including the step of selecting an air stream volumetric flow rate and an infrared energy density to effectuate a pre-determined Maillard reaction on at least part of the food product surface at the end of a first time period, without burning the food product.

9. The method of claim 8, wherein the first time period is selected to be twenty or more seconds but less than forty five seconds.

10. The method of claim 8, wherein the first time period is selected to be twenty or more seconds but less than thirty five seconds.

11. The method of claim 8, wherein the food product is an English muffin having an irregular surface.

12. A method of heating a food product having comprising the steps of:
irradiating the food product from an infrared energy source having a first emitted energy density, for a first time period while simultaneously directing an unheated air stream toward a surface of the food product;
at the expiration of the first time period, reducing the first energy density output to a second energy density output; and
continuing to irradiate the food product at the second energy output for a second time period while maintaining the unheated air stream toward the food product;
whereby the food product is not burned at the end of the second time period.

13. The method of claim 11, wherein the unheated air stream is comprised of at least one substantially columnar air stream, at least partially surrounded by infrared energy directed toward said food product.

14. The method of claim 12, including the step of selecting the first power level and the second power level, to effectuate a pre-determined Maillard reaction on at least part of the food product surface at the end of the second time period without burning the food product.

15. The method of claim 12, wherein the sum of the first time period and the second time period is selected to be greater than or equal to twenty seconds and less than forty five (45) seconds.

16. The method of claim 12, wherein the sum of the first time period and the second time period is selected to be greater than or equal to twenty seconds and less than thirty five (35) seconds.

17. The method of claim 11, wherein the second emitted energy density is between about 85% and about 95% of the first emitted energy density.

18. A method of heating a food product comprising the steps of:
irradiating the food product from an infrared energy source having a first emitted energy density, for a first time period while simultaneously directing an unheated air stream toward the food product;
at the expiration of the first time period, changing the volumetric flow rate of the unheated air stream to a second volumetric flow rate; and
irradiating the food product at the first emitted energy density, for a second time period, maintaining the unheated air stream at the second volumetric flow rate during the second time period;
whereby the food product is not burned at the end of the second time period.

19. The method of claim 18, wherein the second volumetric flow rate is greater than the first volumetric flow rate.

20. The method of claim 18, wherein the unheated air stream is comprised of at least one substantially columnar air stream, at least partially surrounded by infrared energy directed toward said food product.

21. The method of claim 18, including the step of selecting the first volumetric flow rate and the second volumetric flow rate, to effectuate a pre-determined Maillard reaction on the food product surface at the end of the second time period without burning the food product.

22. The method of claim 18, wherein the sum of the first time period and the second time period is selected to be greater than or equal to twenty seconds and less than forty five (45) seconds.

23. The method of claim 20, wherein the sum of the first time period and the second time period is selected to be greater than or equal to twenty seconds and less than thirty five (35) seconds.

24. A toaster for a food product having a surface to be toasted, the toaster comprised of:
an infrared heater comprised of an electrically heated filament having a first emitted energy density and which is configured to direct infrared energy toward a food product; and
a blower directing at least one unheated air stream toward the food product, the at least one unheated air stream having a first volumetric flow rate and a first discharge temperature;
whereby the infrared heater and the blower are configured such that the first emitted energy density, the first volumetric flow rate and the first temperature effectuate toasting of at least part of the food product surface at the end of a first time period without burning the food product surface.

25. The toaster of claim 24, wherein the first time period is greater than or equal to twenty seconds but less than about 40 seconds for an English muffin food product.

26. The toaster of claim 24, wherein the blower is capable of selectively producing at least two different volumetric flow rates.

27. The toaster of claim 24, wherein the infrared heater is configured to have at least two different emitted energy density levels.

28. The toaster of claim 24 further comprised of a controller, operatively coupled to the infrared heater, the controller being configured to effectuate the radiation of a first emitted energy density for a first period of time and effectuate the radiation of a second emitted energy density for a second time period.

29. The toaster of claim 24 further comprised of a controller, operatively coupled to the blower, the controller being configured to cause the blower to produce at least first and second volumetric flow rates.

30. The toaster of claim 24 further comprised of a controller, operatively coupled to the blower, the controller being configured to cause the blower to air streams having at least first and second discharge temperatures.
